(19) United States
(12) Patent Application Publication
(10) Pub. No.: US 2013/0166410 A1
(43) Pub. Date: Jun. 27, 2013

(54) PAYMENT AGENCY SYSTEM, USER TERMINAL AND MARKET SERVER

(71) Applicant: Won-Seok LEE, Seoul (KR)

(72) Inventor: Won-Seok LEE, Seoul (KR)

(73) Assignee: KT CORPORATION, Seongnam-City (KR)

(21) Appl. No.: 13/486,570

(22) Filed: Jun. 1, 2012

(30) Foreign Application Priority Data
Dec. 23, 2011 (KR) 10-2011-0141756

(51) Int. Cl. G06Q 30/06

(52) U.S. Cl. 705/26.41

(57) ABSTRACT

A payment agency system, a user terminal, and a market server are provided. The payment agency system includes an issue unit that generates at least one payment ticket according to a request of a user terminal and that transmits the at least one payment ticket to the user terminal; and an accounting processor that receives purchase information and a payment ticket of pay digital contents in which the user terminal purchases from a market server and that performs an accounting processing of the pay digital contents using the payment ticket and the purchase information.

### CROSS-REFERENCE TO RELATED APPLICATION

This application claims priority to and the benefit of Korean Patent Application No. 10-2011-0141756 filed in the Korean Intellectual Property Office on Dec. 23, 2011, the entire contents of which are incorporated herein by reference.

### BACKGROUND OF THE INVENTION

(a) Field of the Invention

The present invention relates to a payment agency system, a user terminal, and a market server, and more particularly, to technology that pays a cost of a pay application or pay contents that purchase in a plurality of marketplaces.

(b) Description of the Related Art

As a smart phone and a smart pad are widely used, a use frequency of an application market has been explosively increased.

Apple opened a software development kit (SDK) for developing an application in iPhone in 2008 and opened an application market, i.e., an App store that can sell the developed application.

Google developed a mobile platform ‘Android’ and opened an Android market that can circulate an application that can use in an Android mobile phone.

In this way, generally, an application market provides a market in a specific terminal platform, for example, in iPhone, Apple provides a market, and in an Android phone, Google provides a market and provides a self application or a content market according to a communication company.

In an Android phone, a Google market or a communication company market may be simultaneously provided, and it is expected that a case where a plurality of marketplaces provide an application or contents in a specific terminal platform will increase.

However, in existing marketplaces, each marketplace may manage a subscriber and registers a subscriber's settlement information and enable to download a pay application and contents. Therefore, when a plurality of markets are provided in a specific terminal platform, each market should manage a market subscriber, and each subscriber should separately have charge means for purchasing a pay application or pay contents.

As a personal information leakage problem continuously occurs, users are sensitive to a personal information leakage problem. In an environment in which several marketplaces are freely made, a market user requests a method that can reliably purchase without providing payment information thereof to each market.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a payment agency system, a user terminal, and a market server having advantages of enabling a plurality of markets not to have a charge means and unnecessary for a plurality of markets to manage a subscriber by performing an agency business of a payment processing such as charge and accounting by interlocking with a plurality of markets in one system.

An exemplary embodiment of the present invention provides a payment agency system including: an issue unit that generates at least one payment ticket according to a request of a user terminal and that transmits the at least one payment ticket to the user terminal; and an accounting processor that receives purchase information and a payment ticket of pay digital contents in which the user terminal purchases from a market server and that performs an accounting processing of the pay digital contents using the payment ticket and the purchase information.

The at least one payment ticket may be formed in a unique code form that can distinguish payment tickets and includes a randomly generated serial number.

The payment agency system may further include an issue DB that matches and stores subscriber information and at least one payment ticket that is issued on the user terminal basis,

wherein the accounting processor may acquire a payment ticket that receives from the market server and the matched subscriber information from the issue DB, generate accounting data using the subscriber information and the purchase information, and transmit the accounting data to a charge system that is determined through the subscriber information.

The charge system may include a deferred payment charge system of a credit card company or a communication provider.

The issue DB may store the at least one payment ticket that is activated or inactivated according to whether it is used, and

The accounting processor may transmit the accounting data and then inactivate a payment ticket that is received from the market server.

The issue unit may receive a payment ticket issuance request including terminal authentication information from the user terminal, request terminal authentication by transmitting the terminal authentication information to a terminal authentication system, and receive the subscriber information when terminal authentication is succeeded.

The issue unit may request and receive payment secret to the user terminal, when the payment ticket issuance request is received, match the at least one payment ticket, the payment secret, and the subscriber information, and store the at least one payment ticket, the payment secret, and the subscriber information on a user terminal basis at the issue DB.

The payment agency system may further include a register that transmits market authentication information that can distinguish a market to at least one market server according to a registration request of the at least one market server of different providers and that matches and stores the market authentication information on a market server basis,

wherein the accounting processor may receive purchase information, a payment ticket, and the market authentication information of pay digital contents in which the user terminal purchases from the market server, determine whether the market server is registered using the market authentication information, and verify whether the market is a market that can perform a payment agency business.

The payment agency system may further include a verification unit that receives the purchase information, the payment ticket, the market authentication information, and a signature that is generated in the user terminal from the market server, and that determines subscriber information in which a payment ticket that receives from the market server is issued in the issue DB, and that generates a signature for verification together with the purchase information by extracting a payment ticket and payment secret that is matched to the subscriber information, and that determines whether the signature that receives from the market server corresponds with the signature for verification,

wherein the accounting processor may generate the accounting data when the verification unit succeeds in signature verification.

The accounting processor may return a charge failure to the market server, if the signature that receives from the market server does not correspond with the signature for verification, and the accounting processor may return a charge success to the market server, if the signature that receives from the market server corresponds with the signature for verification.

Another embodiment of the present invention provides a user terminal including: a payment ticket management unit that receives issue of at least one payment ticket from a payment agency system; and a processor that transmits a payment ticket that is selected by a user in the at least one payment ticket while requesting purchase of pay digital contents by connecting to a market server,

wherein the payment ticket is transferred to the payment agency system by the market server and is used for an accounting processing of the pay digital contents.

The payment ticket management unit may register payment secret in which a user inputs at the payment agency system according to a request of the payment agency system, and

The processor may generate a signature based on purchase information that receives from the market server using the payment secret in which the user inputs and payment secret in which the user selects when the purchase is requested and transmits the payment secret in which the user selects and the signature to the market server.

The processor may generate the signature using payment secret in which a user inputs when the purchase is requested, a payment ticket in which the user selects, and market authentication information, a purchase content identifier, and a purchase content price that are included in the purchase information as an input value of a hash function.

The user terminal may further include a storage unit that stores the at least one payment ticket that is activated or inactivated according to whether it is used,

wherein the processor may inactivate payment secret in which a user selects when the purchase is requested in the at least one payment ticket that is stored at the storage unit.

The user terminal may further include a display unit that displays an active state or an inactive state on the at least one payment ticket basis and that outputs a payment ticket list in which a check box is included on a screen,

wherein the processor may output the payment ticket list on the screen according to a payment ticket request of the market server.

The processor may output the payment ticket list in a web page form in the display unit by interlocking with the market server or output the payment ticket list in the display unit through a terminal menu.

Yet another embodiment of the present invention provides a market server including: a market authentication management unit that requests market registration to a payment agency system and that receives and stores market authentication information; and a charge processor that receives a payment ticket in which a user terminal receives from the payment agency system from the user terminal, and that transmits purchase information, the market authentication information, and the payment ticket of pay digital contents in which the user terminal purchases to the payment agency system, and that requests accounting charge of the pay digital contents.

The market server may further include a transmitting unit that transmits pay digital contents in which the user terminal purchases to the user terminal,

wherein the charge processor may receive a success response or a failure response to an accounting charge request from the payment agency system, and if a success response is received, the charge processor may transmit the pay digital contents to the user terminal, and if a failure response is received, the charge processor may return an accounting failure to the user terminal.

The charge processor may transmit, when the user terminal requests purchase, a management identifier, price information, and market authentication information of pay digital contents in which purchase is requested to the user terminal, and receive a payment ticket and a signature from the user terminal, wherein the signature may be generated based on the management identifier, the price information, payment secret, and the market authentication information in the user terminal, and the charge processor may transmit the payment ticket, the signature, the market authentication information, and a charge request including a management identifier and a price of a content in which the user terminal purchases to the payment agency system.

According to an exemplary embodiment of the present invention, in a market server, user information does not remain except for payment ticket information and a charge cannot occur without user agreement. Further, because a payment agency system can be interlocked with a deferred payment charge system with information that is acquired using terminal authentication information of a user terminal, the payment agency system provides a reliable charge means to a market server. In this way, a payment information exchange and determination method in which a payment agency system, a user, and a marketplace can trust is provided.

Therefore, in a specific terminal platform, a plurality of markets can easily sell an application and contents without a self payment system and an account management function, and a plurality of markets can sell an App or contents to a user terminal without considering a charge means.

Further, it is unnecessary for the user to subscribe to a market or to provide payment information thereof to a market. Further, by using the user's signature, the user can be trusted.

### BRIEF DESCRIPTION OF THE DRAWINGS

FIG. 1 is a schematic diagram of a network according to an exemplary embodiment of the present invention.

FIG. 2 is a block diagram illustrating a configuration of a market server of FIG. 1.

FIG. 3 is a block diagram illustrating a configuration of a user terminal of FIG. 1.

FIG. 4 illustrates an example of a payment ticket selection screen that is provided by a user terminal of FIG. 3.

FIG. 5 is a block diagram illustrating a configuration of a payment agency system of FIG. 1.

FIG. 6 is a flowchart illustrating a process of registering a market server according to an exemplary embodiment of the present invention.

FIG. 7 is a flowchart illustrating a process of issuing a payment ticket of a user terminal according to an exemplary embodiment of the present invention.

FIG. 8 is a flowchart illustrating a process of performing a payment processing using a payment ticket according to an exemplary embodiment of the present invention.

FIG. 9 is a diagram specifically illustrating data that are transmitted at step S317 of FIG. 8.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising”, will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

Hereinafter, a payment agency system, a user terminal, and a market server according to an exemplary embodiment of the present invention will be described in detail with reference to the drawings.

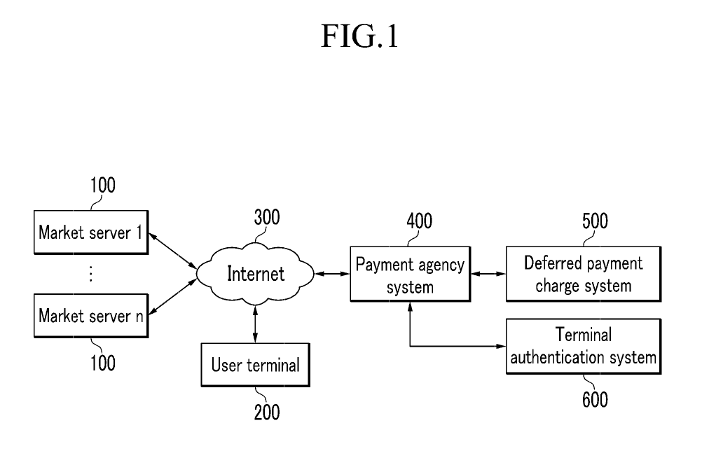

FIG. 1 is a schematic diagram of a network according to an exemplary embodiment of the present invention.

Referring to FIG. 1, a plurality of market servers 1, . . . , n, 100 of different providers and a user terminal 200 are connected to a payment agency system 400 through a network 300. The payment agency system 400 is connected to a deferred payment charge system 500 and a terminal authentication system 600.

Here, the network 300 enables the plurality of market servers 1, . . . , n, 100, the user terminal 200, and the payment agency system 400 to interlock with each other and may be a wired/wireless network.

The plurality of market servers 1, . . . , n, 100 are a server that sells digital contents and may be a server that operates a so-called ‘App store’. Here, digital contents are contents that are manufactured or processed in a digital format and include an application that embodies various functions.

The user terminal 200 purchases pay digital contents by connecting to the plurality of market servers 1, . . . , n, 100 and may be a wireless terminal or a mobile terminal that can transmit and receive data. For example, the user terminal 200 may be a mobile phone, a smart phone, an ultra mobile PC (UMPC), and a personal digital assistance (PDA).

The payment agency system 400 interlocks with the deferred payment charge system 500 and the terminal authentication system 600. Such a payment agency system 400 is an integrated payment means in which a user can purchase pay digital contents in the plurality of market servers 1, . . . , n, 100 and issues a payment ticket to the user terminal 200.

The payment agency system 400 may issue a plurality of payment tickets to the user terminal 200, and in this case, the payment agency system 400 distinguishably issues payment tickets. Therefore, one payment ticket uniquely exists and is formed in a code form that cannot be randomly generated. A payment ticket is a code in which characters or numerals are combined for verification, and code generation may use a method of generating a serial number of a check, a serial number such as a lottery ticket and a gift card, and an authentication code.

The terminal authentication system 600 is a system that can identify the user terminal 200 that is connected to the network 300 and that can identify a subscriber of the user terminal 200. In this case, the terminal authentication system 600 identifies the user terminal 200 and a subscriber using hardware information of the user terminal 200 or an identifier that is downloaded to the user terminal 200. Further, the terminal authentication system 600 manages subscriber information of the user terminal 200. Such subscriber information includes necessary accounting information, i.e., a settlement means when the user terminal 200 purchases in the market server 100. In this case, when a settlement means is a credit card, the subscriber information includes credit card registration information.

In this case, when the payment agency system 400 issues a payment ticket to the user terminal 200, the terminal authentication system 600 extracts subscriber information of the user terminal 200 and provides the subscriber information to the payment agency system 400. Therefore, the payment agency system 400 matches and stores subscriber information and a payment ticket and uses the subscriber information and the payment ticket upon counting later.

The deferred payment charge system 500 accounts a specific amount of money to a subscriber of the user terminal 200, performs a receiving processing of accounting contents, and performs an actual accounting and receiving processing according to accounting data that are received from the payment agency system 400. In general, the deferred payment charge system 500 can be easily performed by a deferred payment charge server of a mobile communication company that can connect to a terminal authentication system, and when a credit card company directly provides a related service, the deferred payment charge system 500 can operate by interlocking with a deferred payment charge server of a credit card company and a terminal authentication system.

One deferred payment charge system 500 is illustrated, but a plurality of deferred payment charge system 500 may exist according to a settlement means of the user terminal 200, and the deferred payment charge system 500 is similar to a deferred payment charge system 500 in which a communication company or a credit card company has.

According to the foregoing description, the user terminal 200 provides a payment ticket in which the payment agency system 400 issues when purchasing pay digital contents in the plurality of market servers 1, . . . , n, 100. Therefore, the payment agency system 400 receives a payment ticket and purchase information in which the user terminal 200 provides from the market server 100 in which the user terminal 200 purchases pay digital contents, generates accounting data, and transfers the accounting data to the deferred payment charge system 500, thereby enabling the deferred payment charge system 500 to perform an actual accounting processing.

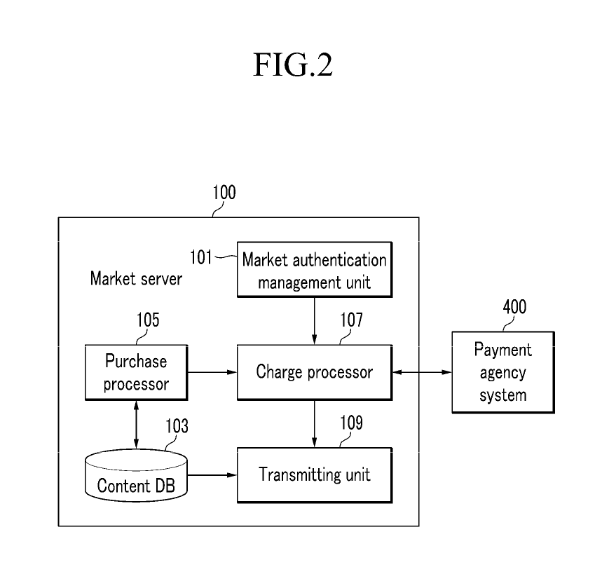

Hereinafter, a detailed configuration of the market server 100, the user terminal 200, and the payment agency system 400 will be described with reference to FIGS. 2 to 5.

FIG. 2 is a block diagram illustrating a configuration of the market server of FIG. 1.

Referring to FIG. 2, the market server 100 includes a market authentication management unit 101, a content DB 103, a purchase processor 105, a charge processor 107, and a transmitting unit 109.

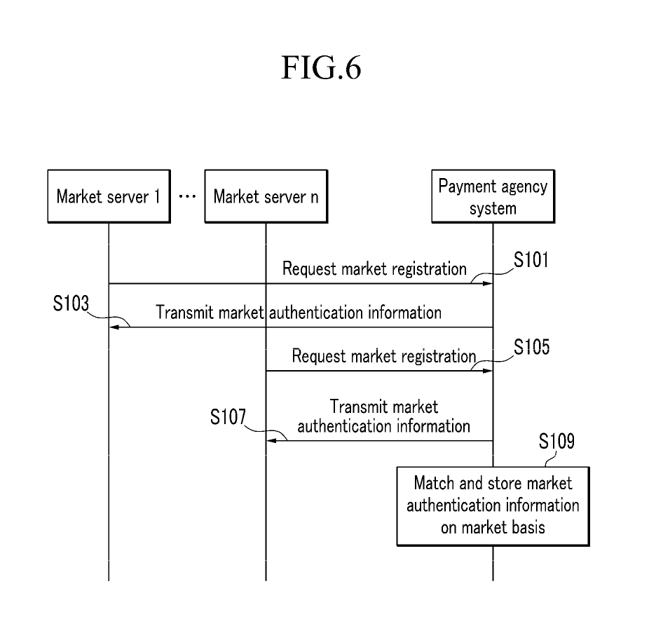

The market authentication management unit 101 registers a market by connecting to the payment agency system 400 and performs a process of FIG. 6 to be described later.

In this case, the market authentication management unit 101 receives and stores market authentication information from the payment agency system 400. Such market authentication information is similar to a certificate that can authenticate or verify that a specific market is a market that is registered to the payment agency system 400.

The content DB 103 stores various pay digital contents and free digital contents that sell in a market in which the market server 100 operates. In this case, each digital content is matched to an intrinsic content management identifier (e.g., ID).

The purchase processor 105 provides various pay digital contents and free digital contents that are stored at the content DB 103 and an interface that can purchase to the user terminal 200. When digital contents in which purchase is requested from the user terminal 200 are pay digital contents, the purchase processor 105 provides purchase information to the user terminal 200.

Here, the purchase information includes content information, a price, and market authentication information as well as a purchased pay digital content identifier.

In this case, the purchase processor 105 provides purchase information to the user terminal 200 and requests a payment ticket and a signature.

The charge processor 107 transmits a payment ticket, a signature, and purchase information that are received from the user terminal 200 to the payment agency system 400, requests a charge, and receives a charge response. In this case, a charge response may be a charge success or a charge failure. When a charge response is a charge failure, notification of a charge failure may be provided to the user terminal 200.

The transmitting unit 109 transmits pay digital contents in which the user to terminal 200 purchases to the user terminal 200 according to a success or a failure of a charge request of the charge processor 107. That is, when a charge request is succeeded, download of purchase contents is allowed.

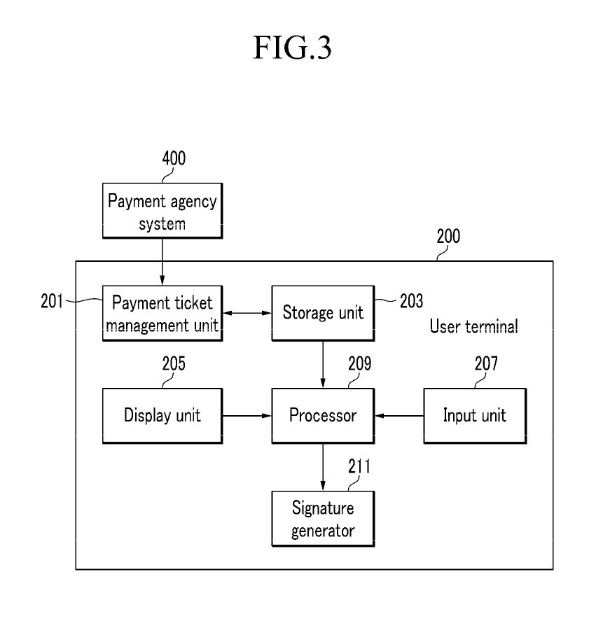

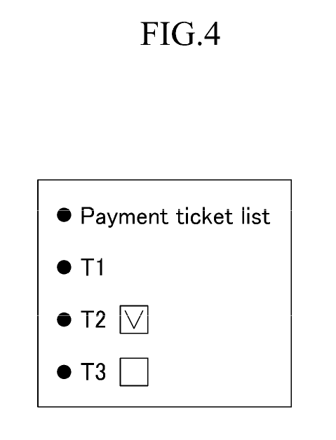

FIG. 3 is a block diagram illustrating a configuration of a user terminal of FIG. 1, and FIG. 4 illustrates an example of a payment ticket selection screen that is provided by a user terminal of FIG. 3.

Referring to FIG. 3, the user terminal 200 includes a payment ticket management unit 201, a storage unit 203, a display unit 205, an input unit 207, a processor 209, and a signature generator 211.

The payment ticket management unit 201 receives a payment ticket from the payment agency system 400 and stores the payment ticket at the storage unit 203. In this case, the payment ticket management unit 201 registers payment secret of the payment ticket at the payment agency system 400. Further, when issuance of a payment ticket is requested, the payment ticket management unit 201 transfers terminal authentication information that is stored at the user terminal 200 to the payment agency system 400, performs terminal authentication, and then receives a payment ticket.

The payment ticket management unit 201 requests purchase using the payment ticket in the market server 100, and when a purchase success response is received, the payment ticket management unit 201 inactivates the used payment ticket.

The payment ticket management unit 201 may receive a plurality of payment tickets and receive several payment tickets at one time or payment tickets at several times. In this case, the issue number of a payment ticket may be limited by the payment agency system 400.

The payment ticket management unit 201 receives an input of payment secret of each or all of issued payment tickets from a user according to a request of the payment agency system 400 and registers the payment secret at the payment agency system 400.

Such payment secret is a password for generating a signature for a payment ticket and is the same as a password in which the user sets to use the payment ticket. That is, when performing a purchase operation at a specific market, the user should select a payment ticket in a purchase information determination window and input payment secret.

The storage unit 203 stores a plurality of payment tickets that are issued by the payment ticket management unit 201. In this case, a used payment ticket is inactivated, and in a non-used payment ticket, active state information that is displayed by activation may be together stored.

The display unit 205 outputs information according to operation of the user terminal 200 on a screen and may use, for example, a presently commercially available liquid crystal display (LCD).

In this case, the display unit 205 outputs a selection screen that can select one of a plurality of payment tickets that are stored at the storage unit 203 and is shown in FIG. 4.

Referring to FIG. 4, the display unit 205 outputs a payment ticket list in which three payment tickets T1, T2, and T3 are listed on a screen. In this case, an already used payment ticket T1 is dimly displayed and may express an inactive state. Non-used, i.e., available payment tickets T2 and T3 are expressed in an active state, and a check box □ is together output and enables a user to select a payment ticket to use.

Referring again to FIG. 3, the input unit 207 generates an input signal according to a user selection. The input unit 207 may be formed in a keypad and a touch screen.

The processor 209 has a configuration for embodying a payment processing operation using a payment ticket and may have a function that is loaded or added to a market client. Here, the market client is a module that is pre-loaded at a terminal by a present policy and that operates by interlocking with the market server 100.

The processor 209 receives purchase information and market authentication information of pay digital contents in which the user requests purchase from the market server 100 and outputs the purchase information and market authentication information on a screen through the display unit 205 in order for the user to determine the purchase information and market authentication information. Here, the purchase information may include application-content information, an application-content price, and market information.

The processor 209 forms a payment ticket selection screen, outputs the payment ticket selection screen through the display unit 205, and when the user selects a specific payment ticket, the processor 209 outputs a payment secret input screen that is set to the selected payment ticket through the display unit 205.

The processor 209 transmits a signature in which the signature generator 211 generates and a payment ticket in which the user selects to the market server 100 and requests purchase.

The signature generator 211 generates a signature using payment secret in which the user inputs through the input unit 207, a payment ticket in which the user selects, and purchase information, i.e., an application-content management value, and application-content price information that receives from the market server 100 as an input value of a hash function and transfers the signature to the processor 209.

In this case, the signature generator 211 may generate a signature using one direction encryption technology such as MD5 or Sha1. Such one direction encryption technology is encryption technology that can be encoded, but that cannot find out original contents with encoded contents and is much used for verifying integrity of corresponding data.

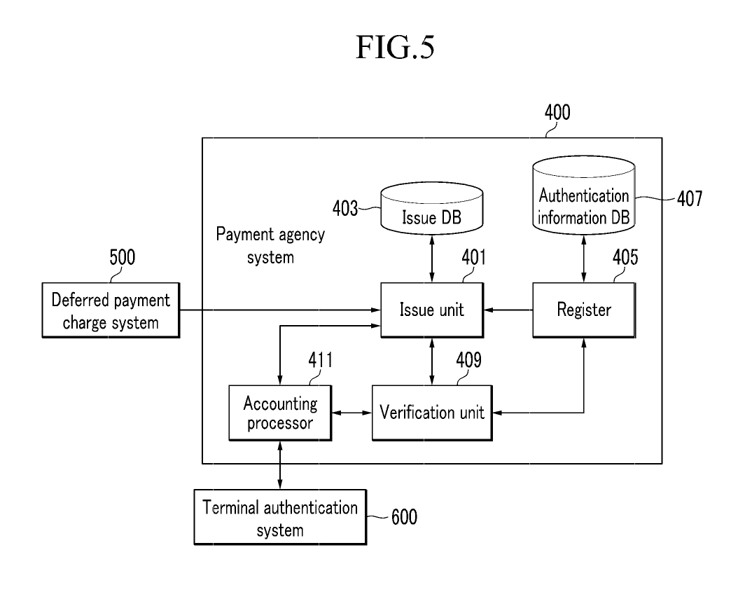

FIG. 5 is a block diagram illustrating a configuration of the payment agency system of FIG. 1.

Referring to FIG. 5, the payment agency system 400 includes an issue unit 401, an issue DB 403, a register 405, an authentication information DB 407, a verification unit 409, and an accounting processor 411.

The issue unit 401 issues at least one payment ticket to the user terminal 200 and stores issuance particulars at the issue DB 403.

The issue unit 401 transfers terminal authentication information that receives from the user terminal 200 to the terminal authentication system 600 and requests terminal authentication. In this case, when terminal authentication is succeeded, the issue unit 401 receives subscriber information, matches the subscriber information to at least one issued payment ticket, and stores the subscriber information at the issue DB 403. Here, the subscriber information includes subscriber identification information and subscriber accounting information, i.e., settlement means information of the user terminal 200.

The issue DB 403 stores matching information of at least one payment ticket that is issued on a subscriber basis, and in each payment ticket, active or inactive state information is matched according to whether the payment ticket is used.

The register 405 performs a process of registering the market server 100 according to a request of the market server 100. In this case, the register 405 generates and provides a key value, i.e., market authentication information for identifying a market to the market server 100, and such market authentication information may be encoded and generated with specific encryption technology.

Further, the market authentication information may be used when requesting verification of a corresponding market from the user terminal 200 to the payment agency system 400.

Further, the market authentication information may be used for an access control of a market in the payment agency system 400.

The certification information DB 407 stores market authentication information that is issued to each of at least one different market server 100.

The verification unit 409 verifies a signature that is received from the market server 100. That is, the verification unit 409 generates a signature for verification using the same function as a hash function that is used in the user terminal 200 based on a payment ticket that is transferred from the market server 100, payment secret that is extracted from a signature that is received from the market server 100, and market verification information and purchase information that is received from the market server 100 and determines whether the signature for verification corresponds with the received signature, thereby verifying the signature. In this case, if the signature for verification corresponds with the received signature, verification is succeeded.

When the verification unit 409 succeeds in verification, the accounting processor 411 generates accounting data and transfers the accounting data to the deferred payment charge system 500. When receiving information is received from the deferred payment charge system 500, the accounting processor 411 settles accounts of the market.

A process of processing payment of pay digital contents using a payment ticket based on a configuration that has been described so far will be described.

In this case, the same reference numerals as those that are used for a configuration of FIGS. 1-4 are used.

FIG. 6 is a flowchart illustrating a process of registering a market server according to an exemplary embodiment of the present invention.

Referring to FIG. 6, the market server 1, 100 requests market registration by connecting to the payment agency system 400 (S101) and receives market authentication information (market 1 authentication value=M1) from the payment agency system 400 (S103). Similarly, the market server n, 100 requests market registration by connecting to the payment agency system 400 (S105) and receives market authentication information (market n authentication value=Mn) from the payment agency system 400 (S107).

Thereafter, the payment agency system 400 matches and stores market authentication information on a market basis (S109).

Therefore, each market server 100 forms an environment that can sell digital contents by interlocking with the payment agency system 400. Further, the each market server 100 manages issued market authentication information M1 and Mn, App/content management values=C1 and Cn of a corresponding market, and App/content sale amount of money=P1 and Pn.

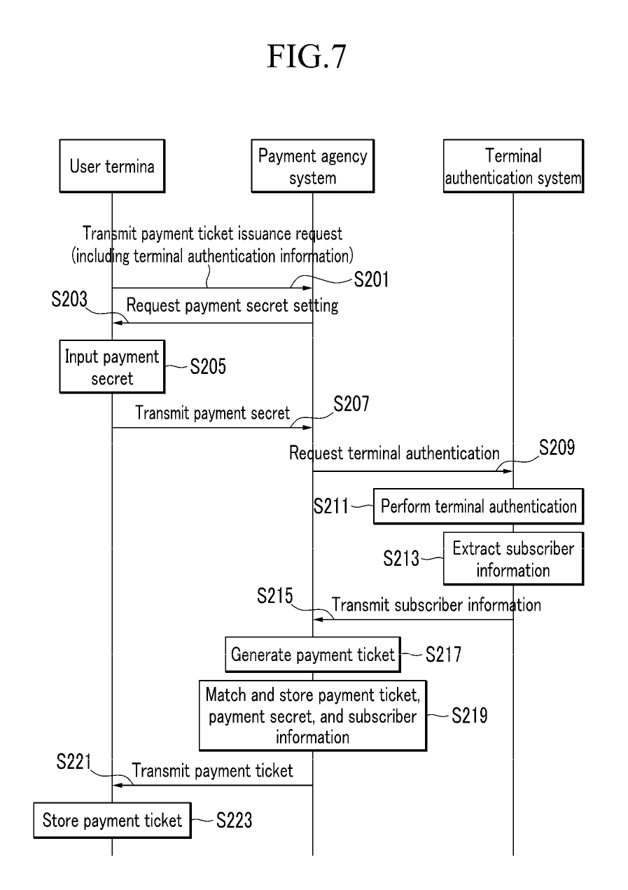

FIG. 7 is a flowchart illustrating a process of issuing a payment ticket of a user terminal according to an exemplary embodiment of the present invention.

Referring to FIG. 7, the user terminal 200 transmits a payment ticket issuance request to the payment agency system 400 (S201), and in this case, the payment ticket issuance request includes terminal authentication information. Such terminal authentication information may be terminal intrinsic information, for example, a terminal phone number, international mobile subscriber identity (IMSI), and terminal hardware information.

Next, the payment agency system 400 requests payment secret setting to the user terminal 200 (S203). Thereafter, in the user terminal 200, payment secret is input by a user (S205), and the user terminal 200 transmits the payment secret that is input by the user to the payment agency system 400 (S207). Such payment secret may be formed in a password form that is combined with several numerals. Alternatively, such payment secret may be an official certificate of authentication.

Next, the payment agency system 400 transmits terminal authentication information that is received at step S201 from the user terminal 200 to the terminal authentication system 600 and requests terminal authentication (S209).

Thereafter, the terminal authentication system 600 performs terminal authentication using terminal authentication information that is received at step S209 (S211), and if terminal authentication is succeeded, the terminal authentication system 600 extracts subscriber information (S213) and transmits the subscriber information to the payment agency system 400 (S215).

When subscriber information is received, the payment agency system 400 determines that terminal authentication is succeeded and generates a payment ticket (S217). The payment agency system 400 matches and stores a payment ticket, payment secret, and subscriber information (S219).

The payment agency system 400 transmits the payment ticket that is generated at step S217 to the user terminal 200 (S221), and the user terminal 200 stores the received payment ticket (S223).

In this case, at least one payment ticket may be issued. Further, when all payment tickets that are stored at the user terminal 200 are used, steps S201-S223 are again repeated.

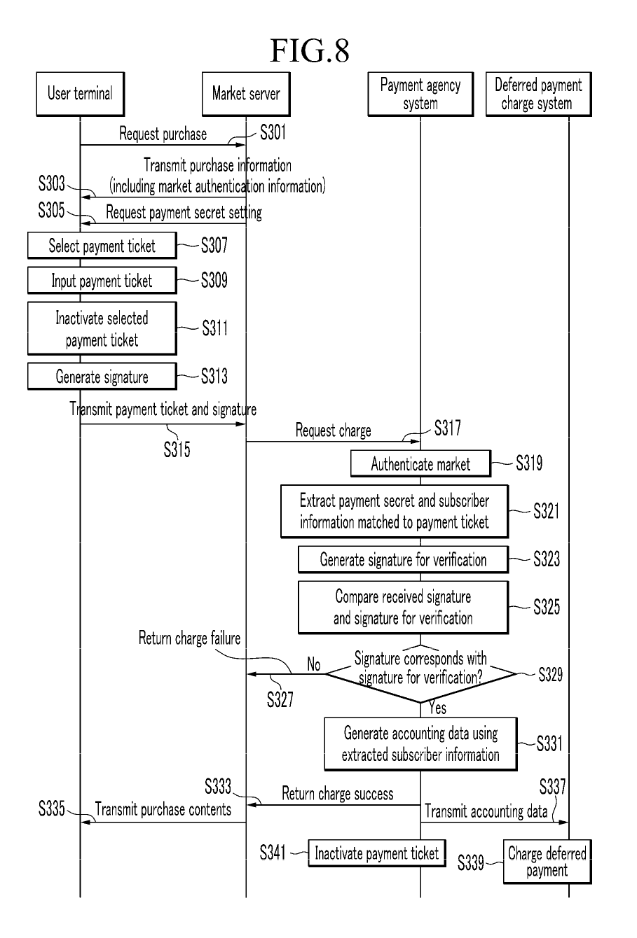

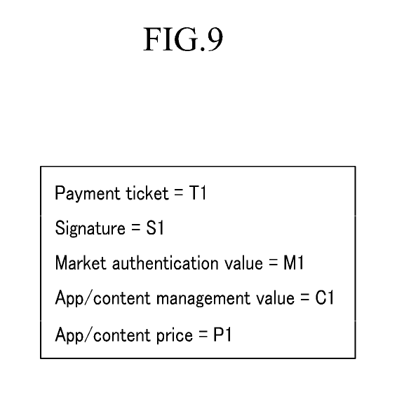

FIG. 8 is a flowchart illustrating a process of performing a payment processing using a payment ticket according to an exemplary embodiment of the present invention, and FIG. 9 is a diagram specifically illustrating data that are transmitted at step S317 of FIG. 8.

Referring to FIG. 8, the user terminal 200 requests purchase of digital contents by connecting to the market server 100 (S301).

Next, the market server 100 transmits purchase information in which market authentication information is included to the user terminal 200 (S303). Such purchase information may be formed with market authentication information=M1, a digital content management value=C1, and a digital content price=P1.

In this case, the user terminal 200 outputs the purchase information that is received at step S303 on a screen and enables a user to view the purchase information.

Next, the market server 100 requests a payment ticket as a settlement means of pay digital contents (S305).

Thereafter, the user terminal 200 outputs at least one previously issued payment ticket on a screen and receives a selection from a user (S307). The user terminal 200 receives an input of payment secret (S309). Here, a screen for selecting a payment ticket and for inputting payment secret may be embodied through a menu of the user terminal 200. Alternatively, a screen for selecting a payment ticket and for inputting payment secret may be embodied through a web page by interlocking with the market server 100.

Next, the user terminal 200 inactivates the payment ticket that is selected at step S307 (S311) and generates a signature (S313). That is, the user terminal 200 generates a signature S1 using a hash function based on a market authentication value M1, a purchase content management value C1, a payment amount P1 and a payment ticket T1, and payment secret Sec.

Next, the user terminal 200 transmits the payment ticket that is selected at step S307 and the signature that is generated at step S313 to the market server 100 (S315).

Thereafter, the market server 100 transmits a charge request to the payment agency system 400 (S317), and the charge request may be formed, as shown in FIG. 9.

Referring to FIG. 9, a charge request includes a payment ticket T1, a signature S1, a market authentication value M1, an App/content (purchased content) management value C1, and an App/content (purchased content) price P1.

Referring again to FIG. 8, the payment agency system 400 inquires whether the market authentication value M1 is a value that is stored at the market authentication information DB 450 and authenticates a market (S319).

Next, the payment agency system 400 extracts payment secret and subscriber information of a subscriber that receives the payment ticket T1 by inquiring the issue DB 430 (S321).

Next, the payment agency system 400 generates a signature for verification using the same hash function as a hash function that is used in the user terminal 200 (S323). That is, the payment agency system 400 generates a signature for verification based on the payment secret that is extracted at step S321, the payment ticket, the market authentication value M1, the App/content value C1, and the App/content price P1 that are received at step S317.

Next, the payment agency system 400 compares the signature that is received at step S317 and the verification signature that is generated at step S323 (S325) and determines whether the signature corresponds with the verification signature (S327).

If the signature does not correspond with the verification signature, the payment agency system 400 may determine that an App/content value C1 and the App/content price P1 that are provided by the market server 100 is faked or a payment ticket T1 and payment secret Sec that is provided by the user terminal 200 is faked. The payment agency system 400 returns a charge failure to the market server 100 (S329). Thereafter, the market server 100 transmits notification of purchase impossibility according to a charge failure to the user terminal 100.

If the signature corresponds with the verification signature, the payment agency system 400 determines the signature as a right signature and generates accounting data using the subscriber information that is extracted at step S321 (S331). In this case, the accounting data include related information to settle accounts according to actual charge and reception. For example, the accounting data may include a subscriber identifier B1, a payment ticket T1, a market authentication value M1, an App/content management value C1, an App/content price P1, payment secret Sec, and a signature S1.

The payment agency system 400 returns a charge success to the market server 100 (S333), and the market server 100 transmits contents in which a user purchases to the user terminal 200 (S335).

Further, the payment agency system 400 transmits accounting data that are generated at step S331 to the deferred payment charge system 500 (S337). Thereafter, the deferred payment charge system 500 performs a charge and receiving process based on accounting data (S339).

Further, the payment agency system 400 inactivates a payment ticket T1 that is used for accounting (S341). If a payment ticket in which a charge is requested later is an inactivated ticket, a charge failure is returned to the market server 100.

The foregoing exemplary embodiment of the present invention may be not only embodied through an apparatus and a method but also embodied through a program that executes a function corresponding to a configuration of the exemplary embodiment of the present invention or through a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A payment agency system comprising:
an issue unit that generates at least one payment ticket according to a request of a user terminal and that transmits the at least one payment ticket to the user terminal; and
an accounting processor that receives purchase information and a payment ticket of pay digital contents in which the user terminal purchases from a market server and that performs an accounting processing of the pay digital contents using the payment ticket and the purchase information.

2. The payment agency system of claim 1, wherein the at least one payment ticket is formed in a unique code form that can distinguish payment tickets and comprises a randomly generated serial number.

3. The payment agency system of claim 1, further comprising an issue DB that matches and stores subscriber information and at least one payment ticket that is issued on the user terminal basis,
wherein the accounting processor acquires a payment ticket that receives from the market server and the matched subscriber information from the issue DB, generates accounting data using the subscriber information and the purchase information, and transmits the accounting data to a charge system that is determined through the subscriber information.

4. The payment agency system of claim 3, wherein the charge system comprises a deferred payment charge system of a credit card company or a communication provider.

5. The payment agency system of claim 3, wherein the issue DB stores the at least one payment ticket that is activated or inactivated according to whether it is used, and
the accounting processor transmits the accounting data and then inactivates a payment ticket that is received from the market server.

6. The payment agency system of claim 3, wherein the issue unit receives a payment ticket issuance request comprising terminal authentication information from the user terminal, requests terminal authentication by transmitting the terminal authentication information to the terminal authentication system, and receives the subscriber information when terminal authentication is succeeded.

7. The payment agency system of claim 6, wherein the issue unit requests and receives payment secret to the user terminal, when the payment ticket issuance request is received, matches the at least one payment ticket, the payment secret, and the subscriber information, and stores the at least one payment ticket, the payment secret, and the subscriber information on a user terminal basis at the issue DB.

8. The payment agency system of claim 6, further comprising a register that transmits market authentication information that can distinguish a market to at least one market server according to a registration request of the at least one market server of different providers and that matches and stores the market authentication information on a market server basis,
wherein the accounting processor receives purchase information, a payment ticket, and the market authentication information of pay digital contents in which the user terminal purchases from the market server, determines whether the market server is registered using the market authentication information, and verifies whether the market is a market that can perform a payment agency business.

9. The payment agency system of claim 8, further comprising a verification unit that receives the purchase information, the payment ticket, the market authentication information, and a signature that is generated in the user terminal from the market server, and that determines subscriber information in which a payment ticket that receives from the market server is issued in the issue DB, and that generates a signature for verification together with the purchase information by extracting a payment ticket and payment secret that is matched to the subscriber information, and that determines whether the signature that receives from the market server corresponds with the signature for verification,
wherein the accounting processor generates the accounting data when the verification unit succeeds in signature verification.

10. The payment agency system of claim 9, wherein the accounting processor returns a charge failure to the market server, if the signature that receives from the market server does not correspond with the signature for verification, and the accounting processor returns a charge success to the market server, if the signature that receives from the market server corresponds with the signature for verification.

11. A user terminal comprising:
a payment ticket management unit that receives issue of at least one payment ticket from a payment agency system; and
a processor that transmits a payment ticket that is selected by a user in the at least one payment ticket while requesting purchase of pay digital contents by connecting to a market server,
wherein the payment ticket is transferred to the payment agency system by the market server and is used for an accounting processing of the pay digital contents.

12. The user terminal of claim 11, wherein the payment ticket management unit registers payment secret in which a user inputs at the payment agency system according to a request of the payment agency system, and
the processor generates a signature based on purchase information that receives from the market server using the payment secret in which the user inputs and payment secret in which the user selects when the purchase is requested and transmits payment secret in which the user selects and the signature to the market server.

13. The user terminal of claim 12, wherein the processor generates the signature using payment secret in which a user inputs when the purchase is requested, a payment ticket in which the user selects, and market authentication information, a purchase content identifier, and a purchase content price that are included in the purchase information as an input value of a hash function.

14. The user terminal of claim 12, further comprising a storage unit that stores the at least one payment ticket that is activated or inactivated according to whether it is used,
wherein the processor inactivates payment secret in which a user selects when the purchase is requested in the at least one payment ticket that is stored at the storage unit.

15. The user terminal of claim 14, further comprising a display unit that displays an active state or an inactive state on the at least one payment ticket basis and that outputs a payment ticket list in which a check box is included on a screen,
wherein the processor outputs the payment ticket list on the screen according to a payment ticket request of the market server.

16. The user terminal of claim 15, wherein the processor outputs the payment ticket list in a web page form in the display unit by interlocking with the market server or outputs the payment ticket list in the display unit through a terminal menu.

17. A market server comprising:
a market authentication management unit that requests market registration to a payment agency system and that receives and stores market authentication information; and
a charge processor that receives a payment ticket in which a user terminal receives from the payment agency system from the user terminal, and that transmits purchase information, the market authentication information, and the payment ticket of pay digital contents in which the user terminal purchases to the payment agency system, and that requests accounting charge of the pay digital contents.

18. The market server of claim 17, further comprising a transmitting unit that transmits pay digital contents in which the user terminal purchases to the user terminal,
wherein the charge processor receives a success response or a failure response to an accounting charge request from the payment agency system, and if a success response is received, the charge processor transmits the pay digital contents to the user terminal, and if a failure response is received, the charge processor returns an accounting failure to the user terminal.

19. The market server of claim 17, wherein the charge processor transmits, when the user terminal requests purchase, a management identifier, price information, and market authentication information of pay digital contents in which purchase is requested to the user terminal, and receives a payment ticket and a signature from the user terminal, wherein the signature is generated based on the management identifier, the price information, payment secret, and the market authentication information in the user terminal, and the charge processor transmits the payment ticket, the signature, the market authentication information, and a charge request comprising a management identifier and a price of a content in which the user terminal purchases to the payment agency system.
